(19) United States
(12) Patent Application Publication
(10) Pub. No.: US 2026/0188576 A1
(43) Pub. Date: Jul. 2, 2026

(54) MULTILAYER CERAMIC CAPACITOR

(71) Applicant: Murata Manufacturing Co., Ltd., Nagaokakyo-shi (JP)

(72) Inventor: Yoshihiro FUKUDA, Nagaokakyo-shi (JP)

(21) Appl. No.: 19/546,804

(22) Filed: Feb. 23, 2026

Related U.S. Application Data
(63) Continuation of application No. PCT/JP2024/022044, filed on Jun. 18, 2024.

(30) Foreign Application Priority Data
Nov. 15, 2023 (JP) 2023-194634

(51) Int. Cl. H01G 4/005; H01G 4/12; H01G 4/232; H01G 4/248; H01G 4/30

(52) U.S. Cl. CPC H01G 4/005; H01G 4/232; H01G 4/248; H01G 4/30; H01G 4/12

(57) ABSTRACT

In a multilayer ceramic capacitor, when a straight line extending in a stacking direction through central portions of a multilayer body is a reference line, any point on a peripheral edge of an inner electrode is a reference point, a distance between the reference point and the reference line is a reference distance, and in the inner electrode, a region in which a distance from the reference point is less than about 5% of the reference distance is a first region, a region in which the distance from the reference point is about 5% to about 15% of the reference distance is a second region, and a region in which the distance from the reference point is about 15% or more of the reference distance is a third region, in an end-surface inner electrode, the first region is smaller than the second region, which is smaller than the third region.

### CROSS REFERENCE TO RELATED APPLICATIONS

This application claims the benefit of priority to Japanese Patent Application No. 2023-194634 filed on Nov. 15, 2023 and is a Continuation Application of PCT Application No. PCT/JP2024/022044 filed on Jun. 18, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

There is known a three-terminal multilayer ceramic capacitor that includes a multilayer body in which a plurality of dielectric layers provided with inner electrodes exposed at end surfaces of the multilayer body and a plurality of dielectric layers provided with inner electrodes exposed at side surfaces of the multilayer body are alternately stacked, end-surface outer electrodes disposed on the end surfaces, and side-surface outer electrodes disposed on the side surfaces (for example, Japanese Unexamined Patent Application Publication No. 2016-127262). With such a configuration, the equivalent series inductance (ESL) of the multilayer ceramic capacitor can be reduced.

### SUMMARY OF THE INVENTION

A multilayer ceramic capacitor is obtained by stacking dielectric sheets each having an inner electrode printed thereon. A step due to the inner electrode may be formed on the dielectric sheet. Therefore, when the dielectric sheets are stacked, structural defects may occur in the multilayer ceramic capacitor due to accumulation of such steps.

In particular, in a three-terminal multilayer ceramic capacitor, structural defects may occur in different modes in regions near respective end surfaces and in regions near respective side surfaces of the multilayer body. Accordingly, the risk of structural defects such as generation of voids may increase.

Example embodiments of the present invention provide multilayer ceramic capacitors that each reduce or prevent structural defects.

A multilayer ceramic capacitor according to an example embodiment of the present invention includes a multilayer body including an inner layer portion including a plurality of dielectric layers and a plurality of inner electrodes alternately stacked on each other, the multilayer body including a first main surface and a second main surface facing each other in a stacking direction, a first side surface and a second side surface facing each other in a width direction orthogonal to the stacking direction, and a first end surface and a second end surface facing each other in a length direction orthogonal to the stacking direction and the width direction, a pair of side-surface outer electrodes provided on the respective side surfaces, and a pair of end-surface outer electrodes provided on the respective end surfaces. The plurality of inner electrodes include an end-surface inner electrode exposed at both of the respective end surfaces and a side-surface inner electrode exposed at both of the respective side surfaces. When a straight line extending in the stacking direction and passing through a position that is a central portion of the multilayer body in the length direction and is a central portion of the multilayer body in the width direction is defined as a reference line, at a position overlapping the reference line, a cross section of the multilayer body extending parallel to the stacking direction is defined as a reference cross section, in the reference cross section, a direction orthogonal to the stacking direction is defined as a reference direction, in the reference cross section, a distance between an end portion of each of the inner electrodes in the reference direction and the reference line is defined as a reference distance, and in the reference cross section, in at least one of the plurality of inner electrodes, a region in which a distance in the reference direction from the end portion in the reference direction is less than about 5% of the reference distance is defined as a first region, a region in which the distance in the reference direction from the end portion in the reference direction is about 5% or more and less than about 15% of the reference distance is defined as a second region, and a region in which the distance in the reference direction from the end portion in the reference direction is about 15% or more of the reference distance is defined as a third region, in the end-surface inner electrode, a dimension in the stacking direction of the first region is less than a dimension in the stacking direction of the second region adjacent to the first region, and the dimension in the stacking direction of the second region is less than a dimension in the stacking direction of the third region adjacent to the second region.

According to example embodiments of the present invention, it is possible to provide multilayer ceramic capacitors that each reduce or prevent structural defects.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along line II-II of FIG. 1.

FIG. 3 is a cross-sectional view taken along line III-III of FIG. 1.

FIG. 4 is a cross-sectional view taken along an end-surface inner electrode 20 of a multilayer body 2.

FIG. 5 is a cross-sectional view taken along a side-surface inner electrode 50 of the multilayer body 2.

### DETAILED DESCRIPTION OF THE EXAMPLE EMBODIMENTS

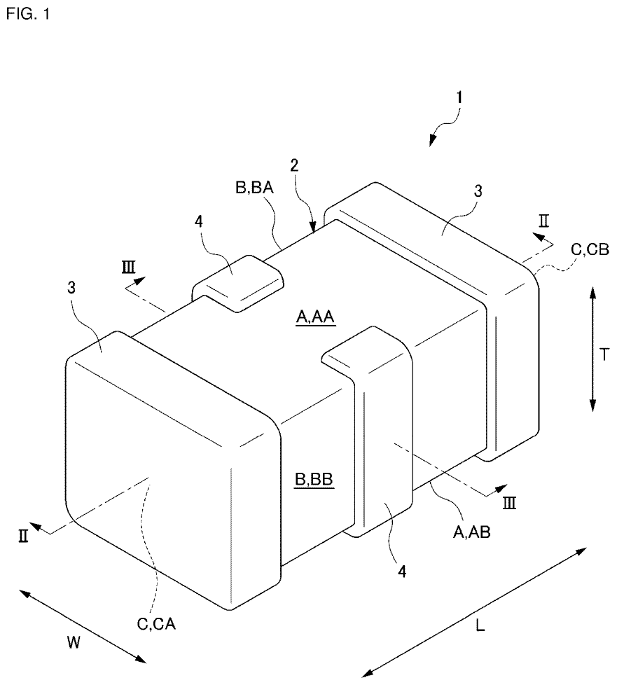

Hereinafter, examples of multilayer ceramic capacitors according to example embodiments of the present invention will be described with reference to FIGS. 1 to 5.

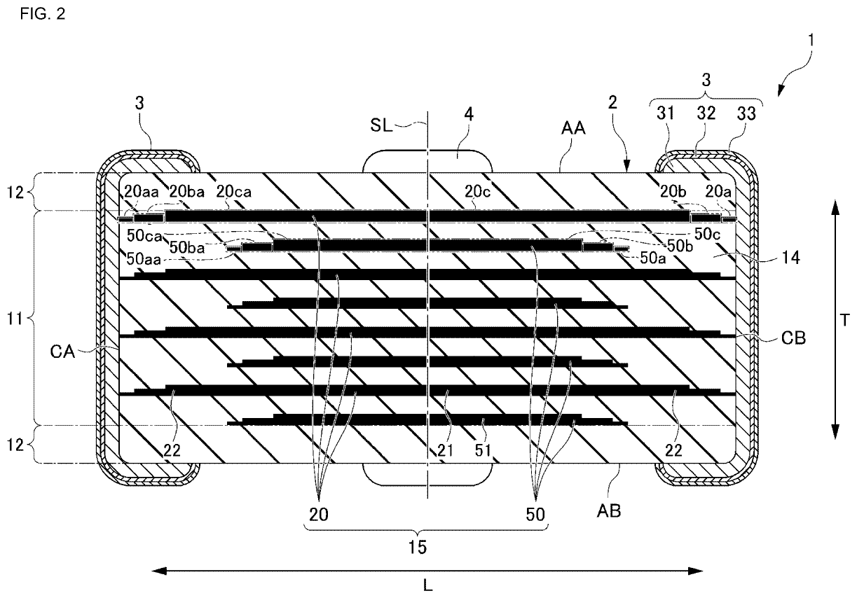

As illustrated in FIG. 1, a multilayer ceramic capacitor 1 is a so-called three-terminal multilayer ceramic capacitor, for example. The multilayer ceramic capacitor 1 includes a multilayer body 2, a pair of end-surface outer electrodes 3, and a pair of side-surface outer electrodes 4. The multilayer body 2 has a substantially rectangular parallelepiped shape and includes six outer surfaces. As illustrated in FIG. 2, the multilayer body 2 includes an inner layer portion 11 in which dielectric layers 14 and inner electrodes 15 are stacked.

In the present description, a direction in which the dielectric layers 14 and the inner electrodes 15 are stacked in the multilayer ceramic capacitor 1 is referred to as a stacking direction T. One of directions orthogonal to the stacking direction T is referred to as a length direction L. The direction orthogonal to both the length direction L and the stacking direction T is referred to as a width direction W.

Among the six outer surfaces of the multilayer body 2, a pair of outer surfaces provided on both sides in the stacking direction T are defined as a first main surface AA and a second main surface AB, a pair of outer surfaces extending in the stacking direction T and provided on both sides in the width direction W are defined as a first side surface BA and a second side surface BB, and a pair of outer surfaces extending in the stacking direction T and provided on both sides in the length direction L are defined as a first end surface CA and a second end surface CB. The first main surface AA and the second main surface AB may collectively be referred to as “respective main surfaces A”. The first side surface BA and the second; side surface BB may collectively be referred to as “respective side surfaces B”. The first end surface CA and the second end surface CB may collectively be referred to as “respective end surfaces C”.

The pair of end-surface outer electrodes 3 are provided on the respective end surfaces C. The pair of side-surface outer electrodes 4 are provided on the respective side surfaces B.

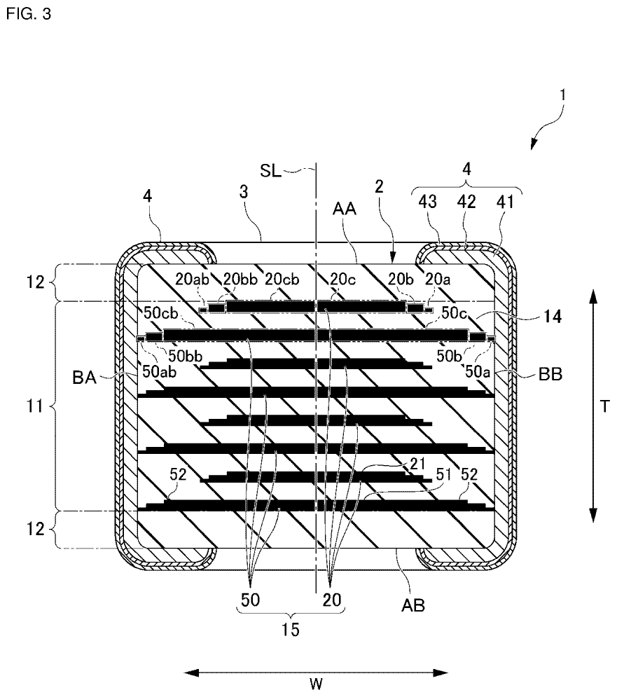

A cross section parallel to the length direction L and the stacking direction T and passing through a central portion in the width direction W of a first lead-out portion 22 is referred to as a “first reference cross section S1”. The cross section of FIG. 2 is the first reference cross section S1. A cross section parallel to the width direction W and the stacking direction T and passing through a central portion in the length direction L of a second lead-out portion 52 is referred to as a “second reference cross section S2”. The cross section of FIG. 3 is the second reference cross section S2.

The multilayer body 2 includes the inner layer portion 11 and a pair of outer layer portions 12 positioned with the inner layer portion 11 interposed therebetween in the stacking direction T. Corners and ridges of the multilayer body 2 are preferably rounded. A corner is a portion where three surfaces of the multilayer body intersect. A ridge is a portion where two surfaces of the multilayer body intersect.

As illustrated in FIGS. 2 and 3, the inner layer portion 11 includes a plurality of dielectric layers 14 and a plurality of inner electrodes 15. The dielectric layers 14 and the inner electrodes 15 are alternately stacked.

The dielectric layers 14 include, for example, a dielectric ceramic including BaTiO₃ as a main component. The dielectric ceramic may include, as a sub-component, a Mn compound, an Fe compound, a Cr compound, a Co compound, a Ni compound, or the like.

The inner electrodes 15 include, for example, a metal material such as Ni, Cu, Ag, Pd, an Ag—Pd alloy, Au, or the like.

The inner electrodes 15 include a plurality of end-surface inner electrodes 20 and a plurality of side-surface inner electrodes 50. The end-surface inner electrodes 20 and the side-surface inner electrodes 50 are alternately disposed in the stacking direction T. The end-surface inner electrodes 20 and the side-surface inner electrodes 50 may collectively be referred to as “inner electrodes 15”.

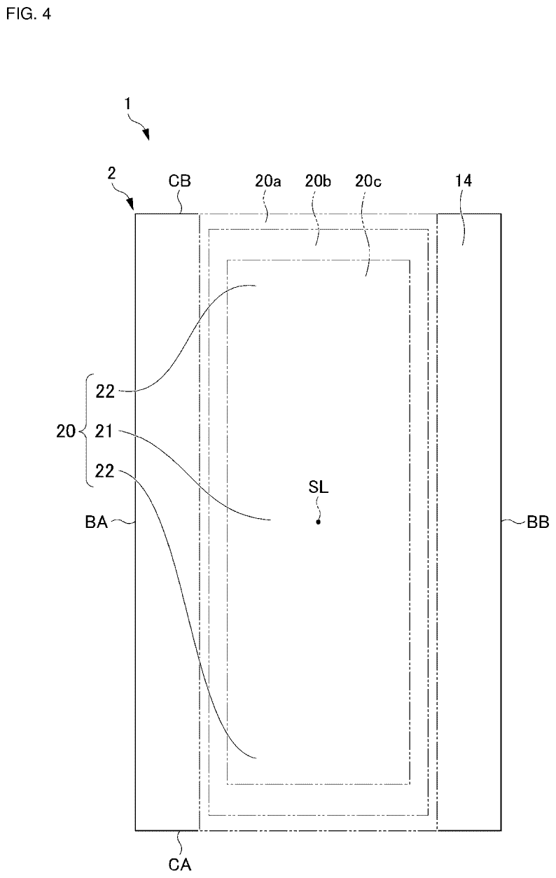

As illustrated in FIG. 4, each end-surface inner electrode 20 extends between both end surfaces C of the multilayer body 2 in the length direction L. Each of the end portions in the length direction L of the end-surface inner electrode 20 is exposed at a corresponding one of the end surfaces C. The end-surface inner electrode 20 is spaced apart from both side surfaces B in the width direction W by a predetermined distance. The end-surface inner electrode 20 includes a first facing portion 21 and two first lead-out portions 22.

The first facing portion 21 is a portion, of the end-surface inner electrode 20, that faces a side-surface inner electrode 50 adjacent thereto in the stacking direction T. The first facing portion 21 is located at a central portion between the respective end surfaces C. Each first lead-out portion 22 is a portion, of the end-surface inner electrode 20, that is led out from the first facing portion 21 toward the corresponding end surface C side. Each first lead-out portion 22 is exposed at the corresponding end surface C.

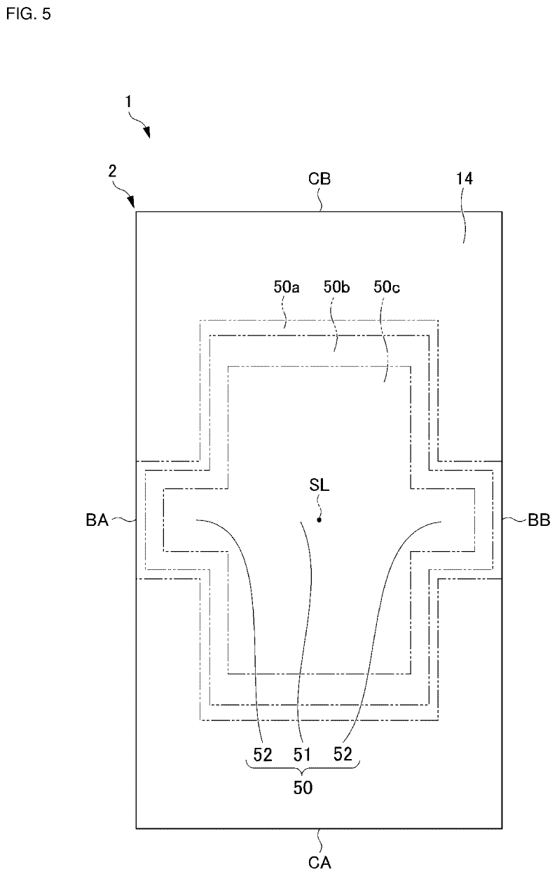

As illustrated in FIG. 5, each of the end portions in the width direction W of each side-surface inner electrode 50 is exposed at a corresponding one of the side surfaces B. The side-surface inner electrode 50 is spaced apart from both end surfaces C in the length direction L by a predetermined distance. The side-surface inner electrode 50 includes a second facing portion 51 and two second lead-out portions 52.

The second facing portion 51 is a portion, of the side-surface inner electrode 50, that faces an end-surface inner electrode 20 adjacent thereto in the stacking direction T. The second facing portion 51 is located at a central portion between the respective side surfaces B. Each second lead-out portion 52 is a portion, of the side-surface inner electrode 50, that is led out from the second facing portion 51 toward the corresponding side surface B side. Each second lead-out portion 52 is exposed at the corresponding side surface B.

The first facing portion 21 and the second facing portion 51 may collectively be referred to as “facing portions 21 and 51”. The first lead-out portions 22 and the second lead-out portions 52 may collectively be referred to as “lead-out portions 22 and 52”.

The outer layer portions 12 include the same material as the dielectric layers 14 of the inner layer portion 11. No inner electrodes 15 are included in the outer layer portions 12.

Each end-surface outer electrode 3 is disposed on the corresponding end surface C of the multilayer body 2. Each end-surface outer electrode 3 covers not only the end surface C but also portions of the main surfaces A and portions of the side surfaces B on the end surface C side. The first lead-out portions 22 are connected to the respective end-surface outer electrodes 3. Each end-surface outer electrode 3 includes a base electrode layer 31 in contact with the surface of the multilayer body 2, a first plating layer 32 on the base electrode layer 31, and a second plating layer 33 on the first plating layer 32.

The base electrode layer 31 is, for example, a baked layer including a conductive metal such as Cu (copper) and glass. The first plating layer 32 is, for example, a Ni (nickel) plating layer. The second plating layer 33 is, for example, a Sn (tin) plating layer.

Each side-surface outer electrode 4 is disposed on the corresponding side surface B of the multilayer body 2. Each side-surface outer electrode 4 covers not only the side surface B but also portions of the main surfaces A on the side surface B side. The second lead-out portions 52 are connected to the respective side-surface outer electrodes 4. Each side-surface outer electrode 4 includes a base electrode layer 41 in contact with the surface of the multilayer body 2, a first plating layer 42 on the base electrode layer 41, and a second plating layer 43 on the first plating layer 42.

The base electrode layer 41 is, for example, a baked layer including a conductive metal such as Cu and glass. The first plating layer 42 is, for example, a Ni plating layer. The second plating layer 43 is, for example, a Sn plating layer.

The end-surface outer electrodes 3 and the side-surface outer electrodes 4 may collectively be referred to as “outer electrodes 3 and 4”.

Here, the thickness of each inner electrode 15 decreases as it approaches each side surface B and each end surface C of the multilayer body 2. Hereinafter, configurations of the end-surface inner electrode 20 and the side-surface inner electrode 50 will be described in more detail. In the present description, the thickness of the inner electrode 15 is the dimension of the inner electrode 15 in the stacking direction T.

A straight line extending in the stacking direction T and passing through a position that is a central portion in the length direction L and a central portion in the width direction W of the multilayer body 2 is referred to as a “reference line SL”. Any point on a peripheral edge portion of the inner electrode 15 is referred to as a “reference point”. A direction orthogonal to the stacking direction T in which the reference point and the reference line SL are arranged is referred to as a “reference direction”. A distance between the reference point and the reference line SL is referred to as a “reference distance”.

In each inner electrode 15, a region in which the distance from the reference point in the reference direction is less than about 5% of the reference distance is defined as a “first region”, a region in which the distance from the reference point in the reference direction is about 5% or more and less than about 15% of the reference distance is defined as a “second region”, and a region in which the distance from the reference point in the reference direction is about 15% or more of the reference distance is defined as a “third region”, for example.

The shape of a peripheral edge of the second region is a shape substantially similar to but smaller than the shape of a peripheral edge of the first region and centered at the reference line SL, and the shape of a peripheral edge of the third region is a shape substantially similar to but smaller than the shape of the peripheral edge of the second region and centered at the reference line SL (see FIGS. 4 and 5). The first region, the second region, and the third region of the end-surface inner electrode 20 are referred to as a first region 20a, a second region 20b, and a third region 20c, respectively (see FIG. 4). The first region, the second region, and the third region of the side-surface inner electrode 50 are referred to as a first region 50a, a second region 50b, and a third region 50c, respectively (see FIG. 5).

First, the state of the inner electrodes 15 in a cross section (i.e., the cross section of FIG. 2) of the multilayer body 2 extending parallel to the stacking direction T and the length direction L and passing through a central portion in the width direction of the multilayer body 2 will be described. The multilayer body 2 has a symmetrical configuration in the length direction L. Therefore, only a region on the first end surface CA side of the multilayer body 2 will be described, and a description of a region on the second end surface CB side will be omitted.

In the cross section of FIG. 2, the reference line passes through the central portion in the length direction L of the multilayer body 2. The reference direction is the length direction L. The reference point is, for example, an end portion on the first end surface CA side of each inner electrode 15. The reference distance is, for example, a distance in the length direction L from the end portion on the first end surface CA side of each inner electrode 15 to the central portion in the length direction L, and is a distance of ½ of the dimension of each inner electrode 15 in the length direction L.

In the cross section of FIG. 2, in the end-surface inner electrode, a region in which the distance in the length direction L from the end portion on the first end surface CA side is less than about 5% of the distance of ½ of the dimension of the end-surface inner electrode 20 in the length direction L is the first region 20a, and is referred to as a “first region 20aa”. In the end-surface inner electrode 20, a region in which the distance in the length direction L from the end portion on the first end surface CA side is about 5% or more and less than about 15% of the distance of ½ of the dimension of the end-surface inner electrode 20 in the length direction L is the second region 20b, and is referred to as a “second region 20ba”. A region in which the distance in the length direction L from the end portion on the first end surface CA side is about 15% or more of the distance of ½ of the dimension of the end-surface inner electrode 20 in the length direction L is the third region 20c, and is referred to as a “third region 20ca”. The boundary between the first region 20aa and the second region 20ba and the boundary between the second region 20ba and the third region 20ca are both located in the first lead-out portion 22.

In the end-surface inner electrode 20, the dimension in the stacking direction T of the first region 20aa is less than the dimension in the stacking direction T of the second region 20ba adjacent to the first region 20aa, and the dimension in the stacking direction T of the second region 20ba is less than the dimension in the stacking direction T of the third region 20ca adjacent to the second region 20ba.

In such a case, the dimension of the end-surface inner electrode 20 in the stacking direction T decreases as it approaches the first end surface CA. The dimension of the first lead-out portion 22 in the stacking direction T decreases as it approaches the first end surface CA. Accordingly, the step due to the end-surface inner electrode 20 can be mitigated, and therefore pressure can be suitably applied to dielectric layers in the vicinity of the inner electrodes during thermocompression bonding (described later) of ceramic green sheets. Thus, structural defects, such as generation of voids, can be reduced or prevented. Therefore, it is possible to provide the multilayer ceramic capacitor 1 that allows structural defects to be reduced or prevented.

In the end-surface inner electrode 20, the dimension in the stacking direction T of the first region 20aa is about 10% or more and less than about 50% of the dimension in the stacking direction T of the third region 20ca, for example.

In the end-surface inner electrode 20, the dimension in the stacking direction T of the second region 20ba is about 50% or more and less than about 80% of the dimension in the stacking direction T of the third region 20ca, for example.

Accordingly, the step due to the end-surface inner electrode 20 can be more suitably mitigated.

In the cross section of FIG. 2, in the side-surface inner electrode, a region in which the distance in the length direction L from the end portion on the first end surface CA side is less than about 5% of the distance of ½ of the dimension of the side-surface inner electrode 50 in the length direction L, for example, is the first region 50a, and is referred to as a “first region 50aa”. In the side-surface inner electrode 50, a region in which the distance in the length direction L from the end portion on the first end surface CA side is about 5% or more and less than about 15% of the distance of ½ of the dimension of the side-surface inner electrode 50 in the length direction L, for example, is the second region 50b, and is referred to as a “second region 50ba”. In the side-surface inner electrode 50, a region in which the distance in the length direction L from the end portion on the first end surface CA side is about 15% or more of the distance of ½ of the dimension of the side-surface inner electrode 50 in the length direction L, for example, is the third region 50c, and is referred to as a “third region 50ca”. The first region 50aa, the second region 50ba, and the third region 50ca each define a portion of the second lead-out portion 52.

In the side-surface inner electrode 50 (second lead-out portion 52), the dimension in the stacking direction T of the first region 50aa is less than the dimension in the stacking direction T of the second region 50ba adjacent to the first region 50aa, and the dimension in the stacking direction T of the second region 50ba is less than the dimension in the stacking direction T of the third region 50ca adjacent to the second region 50ba. Therefore, the dimension of the side-surface inner electrode 50 (second lead-out portion 52) in the stacking direction T decreases as it approaches the first end surface CA.

In the side-surface inner electrode 50, the dimension in the stacking direction T of the first region 50aa is about 10% or more and less than about 50% of the dimension in the stacking direction T of the second region 50ba, for example.

In the side-surface inner electrode 50, the dimension in the stacking direction T of the second region 50ba is about 50% or more and less than about 80% of the dimension in the stacking direction T of the third region 50ca, for example.

Accordingly, the step due to the side-surface inner electrode 50 can be suitably mitigated, and thus structural defects can be reduced or prevented.

Next, a state of the inner electrodes 15 in a cross section (i.e., the cross section of FIG. 3) of the multilayer body 2 extending parallel to the stacking direction T and the width direction W and passing through a central portion in the length direction L of the multilayer body 2 will be described. The multilayer body 2 has a symmetrical configuration in the width direction W. Therefore, only a region on the first side surface BA side of the multilayer body 2 will be described, and a description of a region on the second side surface BB side will be omitted.

In the cross section of FIG. 3, the reference line passes through a central portion in the width direction W of the multilayer body 2. The reference direction is the width direction W. The reference point is, for example, an end portion on the first side surface BA side of each inner electrode 15. The reference distance is, for example, a distance in the width direction W from the end portion on the first side surface BA side of each inner electrode 15 to the central portion in the width direction W, and is a distance of ½ of the dimension of each inner electrode 15 in the width direction W.

In the cross section of FIG. 3, in the end-surface inner electrode 20, a region in which the distance in the width direction W from the end portion on the first side surface BA side is less than about 5% of the distance of ½ of the dimension of the end-surface inner electrode 20 in the width direction W, for example, is the first region 20a, and is referred to as a “first region 20ab”. In the end-surface inner electrode 20, a region in which the distance in the width direction W from the end portion on the first side surface BA side is about 5% or more and less than about 15% of the distance of ½ of the dimension of the end-surface inner electrode 20 in the width direction W, for example, is the second region 20b, and is referred to as a “second region 20bb”. In the end-surface inner electrode 20, a region in which the distance in the width direction W from the end portion on the first side surface BA side is about 15% or more of the distance of ½ of the dimension of the end-surface inner electrode 20 in the width direction W, for example, is the third region 20c, and is referred to as a “third region 20cb”. The first region 20ab, the second region 20bb, and the third region 20cb each define a portion of the first facing portion 21.

In the end-surface inner electrode 20, the dimension in the stacking direction T of the first region 20ab is less than the dimension in the stacking direction T of the second region 20bb adjacent to the first region 20ab, and the dimension in the stacking direction T of the second region 20bb is less than the dimension in the stacking direction T of the third region 20cb adjacent to the second region 20bb. Therefore, the dimension of the end-surface inner electrode 20 (first facing portion 21) in the stacking direction T decreases as it approaches the first side surface BA.

In the end-surface inner electrode 20, the dimension in the stacking direction T of the first region 20ab is about 10% or more and less than about 50% of the dimension in the stacking direction T of the second region 20bb, for example.

In the end-surface inner electrode 20, the dimension in the stacking direction T of the second region 20bb is about 50% or more and less than about 80% of the dimension in the stacking direction T of the third region 20cb, for example.

Accordingly, the step due to the end-surface inner electrode 20 can be suitably mitigated, and thus the end-surface inner electrode 20 and the dielectric layer 14 can be brought into close contact more suitably. Therefore, structural defects can be reduced or prevented.

In the cross section of FIG. 3, in the side-surface inner electrode 50, a region in which the distance in the width direction W from the end portion on the first side surface BA side is less than about 5% of the distance of ½ of the dimension of the side-surface inner electrode 50 in the width direction W, for example, is the first region 50a, and is referred to as a “first region 50ab”. In the side-surface inner electrode 50, a region in which the distance in the width direction W from the end portion on the first side surface BA side is about 5% or more and less than about 15% of the distance of ½ of the dimension of the side-surface inner electrode 50 in the width direction W, for example, is the second region 50b, and is referred to as a “second region 50bb”. In the side-surface inner electrode 50, a region in which the distance in the width direction W from the end portion on the first side surface BA side is about 15% or more of the distance of ½ of the dimension of the side-surface inner electrode 50 in the width direction W, for example, is the third region 50c, and is referred to as a “third region 50cb”. The boundary between the first region 50ab and the second region 50bb and the boundary between the second region 50bb and the third region 50cb are both located in the second lead-out portion 52.

In the side-surface inner electrode 50 (second lead-out portion 52), the dimension in the stacking direction T of the first region 50ab is less than the dimension in the stacking direction T of the second region 50bb adjacent to the first region 50ab, and the dimension in the stacking direction T of the second region 50bb is less than the dimension in the stacking direction T of the third region 50cb adjacent to the second region 50bb.

Therefore, the dimension of the side-surface inner electrode 50 in the stacking direction T decreases as it approaches the first side surface BA. The dimension of the second lead-out portion 52 in the stacking direction T decreases as it approaches the first side surface BA.

In the side-surface inner electrode 50, the dimension in the stacking direction T of the first region 50ab is about 10% or more and less than about 50% of the dimension in the stacking direction T of the second region 50bb, for example.

In the side-surface inner electrode 50, the dimension in the stacking direction T of the second region 50bb is about 50% or more and less than about 80% of the dimension in the stacking direction T of the third region 50cb, for example.

Accordingly, the step due to the side-surface inner electrode 50 can be suitably mitigated, and therefore pressure can be suitably applied to dielectric layers in the vicinity of the inner electrodes during thermocompression bonding (described later) of ceramic green sheets. Thus, structural defects can be reduced or prevented.

In an example of a method for measuring thickness of inner electrodes 15, first, the multilayer body is polished to expose an observation surface described later. Next, the exposed observation surface is observed with a microscope to measure the thickness of an inner electrode. At this time, the thickness of the inner electrode can be obtained by measuring the thickness of the inner electrode at a plurality of points within a predetermined range, and calculating, as the thickness of the inner electrode, an average value of the measured values. Specifically, the observation surface is observed with a scanning electron microscope (SEM). The observation magnification is set to 10,000. The thickness of the inner electrode 15 is measured in a region having a field size of 10 μm×10 μm. The thickness of the inner electrode 15 is measured at any three points. An average value of the measured values obtained at the three points is defined as the thickness of the inner electrode 15.

The observation surface is a cross section parallel to the stacking direction T. The state of each end portion in the length direction L of the first lead-out portion 22 of the end-surface inner electrode 20 and the state of each end portion in the length direction L of the second facing portion 51 of the side-surface inner electrode 50 can be observed, for example, by using, as the observation surface, an LT cross section passing through the central portion in the width direction W of the multilayer body 2.

The state of each end portion in the width direction W of the first facing portion 21 of the end-surface inner electrode 20 and the state of each end portion in the width direction W of the second lead-out portion 52 of the side-surface inner electrode 50 can be observed, for example, by using, as the observation surface, a WT cross section passing through the central portion in the length direction L of the multilayer body 2.

The state of each end portion in the width direction W of the second lead-out portion 52 of the side-surface inner electrode 50 can be observed, for example, by using, as the observation surface, an LT cross section passing through the third region 50c of the second lead-out portion 52 of the side-surface inner electrode 50.

Note that such a cross section is spaced apart from the reference line. However, in such a cross section, in the side-surface inner electrode 50, a region in which the distance in the width direction W from the end portion on the first side surface BA side is less than about 5% of the distance of ½ of the dimension of the side-surface inner electrode 50 in the width direction W coincides with the first region 50a, for example. In the side-surface inner electrode 50, a region in which the distance in the width direction W from the end portion on the first side surface BA side is about 5% or more and less than about 15% of the distance of ½ of the dimension of the side-surface inner electrode 50 in the width direction W, for example, coincides with the second region 50b. In the side-surface inner electrode 50, a region in which the distance in the width direction W from the end portion on the first side surface BA side is about 15% or more of the distance of ½ of the dimension of the side-surface inner electrode 50 in the width direction W, for example, coincides with the third region 50c. Therefore, the thickness of the first region 50a, the thickness of the second region 50b, and the thickness of the third region 50c can be observed in such an observation surface.

The state of each end portion in the width direction W of the first lead-out portion 22 of the end-surface inner electrode 20 can be observed, for example, by using, as the observation surface, a WT cross section passing through the third region 20c of the first lead-out portion 22 of the end-surface inner electrode 20.

Note that such a cross section is spaced apart from the reference line. However, also in such a cross section, in the side-surface inner electrode (specifically, the second lead-out portion 52), a region in which the distance in the length direction L from the end portion on the first end surface CA side is less than about 5% of the distance of ½ of the dimension of the side-surface inner electrode 50 in the length direction L, for example, coincides with the first region 50a. In the side-surface inner electrode 50, a region in which the distance in the length direction L from the end portion on the first end surface CA side is about 5% or more and less than about 15% of the distance of ½ of the dimension of the side-surface inner electrode 50 in the length direction L, for example, coincides with the second region 50b. In the side-surface inner electrode 50, a region in which the distance in the length direction L from the end portion on the first end surface CA side is about 15% or more of the distance of ½ of the dimension of the side-surface inner electrode 50 in the length direction L, for example, coincides with the third region 50c. Therefore, the thickness of the first region 50a, the thickness of the second region 50b, and the thickness of the third region 50c can be observed in such an observation surface.

The observation surface is not limited to an LT cross section or a WT cross section, and may be any cross section intersecting each of the length direction L and the width direction W.

Next, a non-limiting example of a method of manufacturing the multilayer ceramic capacitor 1 according to an example embodiment will be described.

First, ceramic green sheets obtained by forming a ceramic slurry into a sheet shape are prepared. Next, patterns of the end-surface inner electrodes 20 and the side-surface inner electrodes 50 are printed on the ceramic green sheets using a conductive paste. By performing the above step, ceramic green sheets provided with the end-surface inner electrodes 20 and ceramic green sheets provided with e side-surface inner electrodes 50 are obtained. The patterns of the inner electrodes are formed by, for example, gravure printing or screen printing.

Here, on the printed patterns of the end-surface inner electrodes 20 and the side-surface inner electrodes 50, patterns of the end-surface inner electrodes 20 and the side-surface inner electrodes 50 are further printed using a conductive paste. The inner electrode pattern to be printed in the second printing is printed to be slightly smaller than the inner electrode pattern printed in the first printing, and is printed, for example, as a shape similar to but smaller than the shape of the inner electrode pattern printed in the first printing and centered at a central portion in the length direction L and the width direction W of the inner electrode pattern printed in the first printing. A peripheral edge portion of the inner electrode pattern printed in the second printing is spaced apart from a peripheral edge portion of the inner electrode pattern printed in the first printing by a distance of, for example, approximately 5% of ½ of the distance between the peripheral edge portion and the central portion of the inner electrode pattern printed in the first printing.

Similarly, on the patterns of the end-surface inner electrodes 20 and the side-surface inner electrodes 50 printed in the second printing, patterns of the end-surface inner electrodes 20 and the side-surface inner electrodes 50 are further printed using a conductive paste. The inner electrode pattern to be printed in the third printing is printed to be slightly smaller than the inner electrode pattern printed in the second printing, and is printed, for example, as a shape similar to but smaller than the shape of the inner electrode pattern printed in the second printing and centered at a central portion in the length direction L and the width direction W of the inner electrode pattern printed in the second printing. A peripheral edge portion of the inner electrode pattern printed in the third printing is spaced apart from the peripheral edge portion of the inner electrode pattern printed in the first printing by a distance of, for example, approximately 15% of ½ of the distance between the peripheral edge portion and the central portion of the inner electrode pattern printed in the first printing.

Accordingly, the inner electrode patterns having a thickness that decreases toward the peripheral edge portion are formed on the ceramic green sheets. The thickness of the inner electrode patterns printed in the respective printing operations may differ from each other. The thickness of the inner electrode patterns can be adjusted by adjusting the amount of conductive paste applied.

Next, the ceramic green sheets provided with the end-surface inner electrodes 20 and the ceramic green sheets provided with the side-surface inner electrodes 50 are alternately stacked. Next, ceramic green sheets for the outer layer portions to become the outer layer portions 12 are stacked on both sides of the stacked ceramic green sheets in the stacking direction T. The ceramic green sheets for outer layer portions are the thermocompression-bonded to the stacked ceramic green sheets. By performing the above step, a mother block is obtained.

Each outer layer portion 12 may be formed by stacking a plurality of ceramic green sheets, or may be formed of a single ceramic green sheet. The ceramic green sheets for the inner layer portion and the ceramic green sheets for the outer layer portions may contain different components.

Next, the mother block is divided along cutting lines corresponding to dimensions of the multilayer body. The mother block is cut, for example, in the length direction L and the width direction W. By performing the above step, a plurality of rectangular-parallelepiped blocks (referred to as “multilayer chips”) are obtained. The multilayer chips are preferably rounded at corners and ridges by, for example, barrel polishing.

Next, the multilayer chips are heated for a predetermined time at a predetermined firing temperature in a nitrogen atmosphere. By performing the above step, the multilayer body 2 is obtained.

Next, the base electrode layers 41 of the side-surface outer electrodes 4 are formed on the respective side surfaces B of the multilayer body 2. Each base electrode layer 41 is formed so as to cover not only the side surface B, but also portions of the main surfaces A on the side surface B side. Next, the base electrode layers 31 of the end-surface outer electrodes 3 are formed on the respective end surfaces C of the multilayer body 2. Each base electrode layer 31 is formed so as to cover not only the end surface C, but also portions of the main surfaces A and side surfaces B on the end surface C side.

Next, the multilayer body 2 on which the base electrode layers 31 and the base electrode layers 41 are formed is heated for a predetermined time at a predetermined firing temperature in a nitrogen atmosphere. By performing the above step, the base electrode layers 31 and the base electrode layers 41 are baked onto the multilayer body 2.

Next, Ni plating layers 32 are formed on the base electrode layers 31. Ni plating layers 42 are formed on the base electrode layers 41. The Ni plating layers 32 and the Ni plating layers 42 are formed by, for example, a barrel plating method. Next, Sn plating layers 33 are formed on the Ni plating layers 32. Sn plating layers 43 are formed on the Ni plating layers 42. The Sn plating layers 33 and the Sn plating layers 43 are formed by, for example, a barrel plating method. By performing the above step, the end-surface outer electrodes 3 and the side-surface outer electrodes 4 are formed on the multilayer body 2.

By performing the above steps, the multilayer ceramic capacitor 1 illustrated in FIG. 1 is obtained.

Multilayer ceramic capacitors were manufactured as samples of experimental examples of the above-described manufacturing method. In each experimental example, the thickness of the first region 20a and the thickness of the second region 20b of each end-surface inner electrode 20 were changed, whereas the thickness of the third region 20c of the end-surface inner electrode 20 and the thicknesses of the respective regions of each side-surface inner electrode 50 were each kept constant. Measurements were performed for each experimental example to determine the presence or absence of voids in the multilayer body and measure the value of the electrostatic capacitance (Cap) and the value of DC resistance (Rdc) of the ceramic capacitor.

As samples of experimental examples, the multilayer ceramic capacitors having the structure illustrated in FIGS. 1 to 5 and the following example specifications were manufactured using the manufacturing method according to the example embodiments.
Dimensions of multilayer ceramic capacitor: L×W×T=1.0 mm×0.5 mm×0.4 mm
Material (main component) of dielectric layers: BaTiO₃
Rated voltage: 6.3 V
Thickness of dielectric layers: 1 μm
End-surface inner electrodes
Material: Ni
Shape: shape illustrated in FIG. 4
Number of end-surface inner electrodes: 65
Thickness of third region: 0.65 μm
Thickness of second region: see tables
Thickness of first region: see tables
(Thickness of first region/thickness of third region)×100: see tables
(Thickness of second region/thickness of third region)×100: see tables
Side-surface inner electrodes
Material: Ni
Shape: shape illustrated in FIG. 5
Number of side-surface inner electrodes: 65
Thickness (μm) of third region: 0.65 μm
Thickness (μm) of second region: 0.65 μm
Thickness (μm) of first region: 0.65 μm
End-surface outer electrodes
Base electrode layer: baked layer including conductive metal (Cu) and glass component
Thickness of central portion of end surface: about 25 μm
Plating layer: two layers including Ni plating layer and Sn plating layer
Thickness of Ni plating layer: 3 μm
Thickness of Sn plating layer: 4 μm
Side-surface outer electrodes
Base electrode layer: baked layer including conductive metal (Cu) and glass component
Thickness of central portion of side surface: about 20 μm
Plating layer: two layers including Ni plating layer and Sn plating layer
Thickness of Ni plating layer: 3 μm
Thickness of Sn plating layer: 4 μm

The manufactured samples were evaluated in accordance with the following measuring method.

Measurements were performed by the above-described method for measuring the thickness of the inner electrodes. In the LT cross section passing through the central portion in the width direction W of the multilayer body 2, the thickness of an inner electrode was measured at three locations for each of the first region, the second region, and the third region. Further, in the WT cross section passing through the central portion in the length direction L of the multilayer body 2, the thickness of the inner electrode was measured at three locations for each of the first region, the second region, and the third region. Thus, six measured values were obtained for each region of the end-surface inner electrode 20. An average of the obtained values was defined as the thickness of each region of the end-surface inner electrode 20.

Measurements were performed by the above-described method for measuring the thickness of the inner electrodes. In the LT cross section passing through the third region 50c of the second lead-out portion 52 of a side-surface inner electrode 50, the thickness of the inner electrode was measured at three locations per region for each of the first region, the second region, and the third region. In the LT cross section passing through the central portion in the width direction W of the multilayer body 2, the thickness of the inner electrode was measured at three locations per region for each of the first region, the second region, and the third region. In the WT cross section passing through the third region 50c of the second facing portion 51 of the side-surface inner electrode 50, the thickness of the inner electrode was measured at three locations per region for each of the first region, the second region, and the third region. In the WT cross section passing through the central portion in the length direction L of the multilayer body 2, the thickness of the inner electrode was measured at three locations per region for each of the first region, the second region, and the third region. Thus, twelve measured values were obtained for each region of the side-surface inner electrode 50. An average of the obtained values was defined as the thickness of each region of the side-surface inner electrode 50.

When the thickness of an inner electrode is measured in an LT cross section, the measurement may be performed only in one of two regions obtained by dividing the multilayer body 2 into two equal portions in the width direction W. When the thickness of an inner electrode is measured in a WT cross section, the measurement may be performed only in one of two regions obtained by dividing the multilayer body 2 into two equal portions in the length direction L.

Among pores present in the dielectric layers 14, a pore having longitudinal and lateral lengths of 5 μm or more was defined as a “void”. The multilayer ceramic capacitor 1 was polished to expose a WT cross section passing through the central portion in the length direction L. The polished surface was observed with a microscope, and whether a void was present in the vicinity of both ends of the inner electrode 15 was confirmed. The observation magnification was set to 500.

When a void was present at even one location in one multilayer body 2, the multilayer body 2 was determined as “void present”. Among 50 multilayer ceramic capacitors 1, when the number of multilayer ceramic capacitors 1 determined as “void present” was 0, the determination result was “Excellent”; when the number of multilayer ceramic capacitors 1 determined as “void present” was 1 to 5, the determination result was “Good”; and when the number of multilayer ceramic capacitors 1 determined as “void present” was 6 or more, the determination result was “Poor”.

A C meter was used to measure the electrostatic capacitance between the end-surface inner electrode 20 and the side-surface inner electrode 50. The measurement frequency was 1 kHz and the measurement voltage was 0.5 V. For each experimental example, 30 multilayer ceramic capacitors 1 were prepared, measurement was performed once for each multilayer ceramic capacitor 1, and an average value of the obtained values was defined as the value of the electrostatic capacitance (Cap) of the experimental example. When the value of the electrostatic capacitance was 1.00 or more, the determination result was “Good”, and when the value of the electrostatic capacitance was less than 1.00, the determination result was “Poor”.

A potential difference V between the end-surface outer electrodes 3 was measured while a current I=100 mA was applied between the end-surface outer electrodes 3. An average value of 30 measurements was used to obtain a DC resistance Rdc1 by calculating Rdc1=V/I (potential difference/100 mA). When the value of Rdc1 was less than 30 mΩ, the determination result was “Good”, and when the value of Rdc1 was 30 mΩ or more, the determination result was “Poor”.

A potential difference V between the side-surface outer electrodes 4 was measured while a current I=100 mA was applied between the side-surface outer electrodes 4. An average value of 30 measurements was used to obtain a DC resistance Rdc2 by calculating Rdc2=V/I (potential difference/100 mA). When the value of Rdc2 was less than 45 mΩ, the determination result was “Good”, and when the value of Rdc2 was 45 mΩ or more, the determination result was “Poor”.

In Tables 1 and 2, the thickness of each region of the end-surface inner electrode 20, the presence or absence of voids, and the evaluation results of electrostatic capacitance (Cap) and DC resistance (Rdc) are shown for each experimental example. A value of (thickness of the first region/thickness of the third region) of the end-surface inner electrode 20×100 is shown in Table 1, and a value of (thickness of the second region/thickness of the third region) of the end-surface inner electrode 20×100 is shown in Table 2.

Although not shown in Tables 1 and 2, in each experimental example, the thicknesses of the respective regions of the side-surface inner electrode 50 were each constant at 0.65 μm. In Tables 1 and 2 as well as the following description, in the end-surface inner electrode 20, the thickness of the first region 20a may be referred to as “A-thickness”, the thickness of the second region 20b may be referred to as “B-thickness”, the thickness of the third region 20c may be referred to as “C-thickness”, a value of (the thickness of the first region/the thickness of third region)×100 may be referred to as an “A/C thickness ratio”, and a value of (the thickness of the second region of the end-surface inner electrode 20/the thickness of the third region of the end-surface inner electrode 20)×100 may be referred to as a “B/C thickness ratio”.

TABLE 1

| | Thickness of end-surface | | | | | | | | | | | |
|---|---|---|---|---|---|---|---|---|---|---|---|---|
| | inner electrodes 20 | | | | | | | | | | | |
| | | | | A/C | Voids | | Electrostatic | | DC resistance | | DC resistance | |
| | C- | B- | A- | thick- | Number | | capacitance Cap | | Rdc1 | | Rdc2 | |
| | thick- | thick- | thick- | ness | of samples | Determi- | Measured | Determi- | Measured | Determi- | Measured | Determi- |
| | ness | ness | ness | ratio | with voids | nation | value | nation | value | nation | value | nation |
| | (μm) | (μm) | (μm) | (%) | (samples) | result | (μF) | result | (mΩ) | result | (mΩ) | result |
| Experimental | 0.65 | 0.65 | 0.65 | 100 | 41 | Poor | 1.03 | Good | 19 | Good | 33 | Good |
| Example 1 | | | | | | | | | | | | |
| Experimental | 0.65 | 0.52 | 0.46 | 70 | 35 | Poor | 1.08 | Good | 23 | Good | 37 | Good |
| Example 2 | | | | | | | | | | | | |
| Experimental | 0.65 | 0.52 | 0.42 | 65 | 28 | Poor | 1.06 | Good | 22 | Good | 32 | Good |
| Example 3 | | | | | | | | | | | | |
| Experimental | 0.65 | 0.52 | 0.39 | 60 | 13 | Poor | 1.07 | Good | 20 | Good | 32 | Good |
| Example 4 | | | | | | | | | | | | |
| Experimental | 0.65 | 0.52 | 0.36 | 55 | 10 | Poor | 1.04 | Good | 25 | Good | 36 | Good |
| Example 5 | | | | | | | | | | | | |
| Experimental | 0.65 | 0.52 | 0.33 | 50 | 6 | Poor | 1.08 | Good | 18 | Good | 39 | Good |
| Example 6 | | | | | | | | | | | | |
| Experimental | 0.65 | 0.52 | 0.30 | 46 | 2 | Good | 1.10 | Good | 22 | Good | 31 | Good |
| Example 7 | | | | | | | | | | | | |
| Experimental | 0.65 | 0.52 | 0.26 | 40 | 0 | Excellent | 1.07 | Good | 20 | Good | 38 | Good |
| Example 8 | | | | | | | | | | | | |
| Experimental | 0.65 | 0.52 | 0.20 | 30 | 0 | Excellent | 1.03 | Good | 21 | Good | 30 | Good |
| Example 9 | | | | | | | | | | | | |
| Experimental | 0.65 | 0.52 | 0.13 | 20 | 0 | Excellent | 1.08 | Good | 19 | Good | 32 | Good |
| Example 10 | | | | | | | | | | | | |
| Experimental | 0.65 | 0.52 | 0.07 | 10 | 0 | Excellent | 1.05 | Good | 23 | Good | 36 | Good |
| Example 11 | | | | | | | | | | | | |
| Experimental | 0.65 | 0.52 | 0.05 | 8 | 0 | Excellent | 1.09 | Good | 34 | Poor | 29 | Good |
| Example 12 | | | | | | | | | | | | |
| Experimental | 0.65 | 0.52 | 0.04 | 6 | 0 | Excellent | 0.88 | Poor | 47 | Poor | 35 | Good |
| Example 13 | | | | | | | | | | | | |

TABLE 2

| | Thickness of end-surface | | | | | | | | | | | |
|---|---|---|---|---|---|---|---|---|---|---|---|---|
| | inner electrodes 20 | | | | | | | | | | | |
| | | | | B/C | Voids | | Electrostatic | | DC resistance | | DC resistance | |
| | C- | B- | A- | thick- | Number | | capacitance Cap | | Rdc1 | | Rdc2 | |
| | thick- | thick- | thick- | ness | of samples | Determi- | Measured | Determi- | Measured | Determi- | Measured | Determi- |
| | ness | ness | ness | ratio | with voids | nation | value | nation | value | nation | value | nation |
| | (μm) | (μm) | (μm) | (%) | (samples) | result | (μF) | result | (mΩ) | result | (mΩ) | result |
| Experimental | 0.65 | 0.65 | 0.65 | 100 | 41 | Poor | 1.07 | Good | 19 | Good | 37 | Good |
| Example 14 | | | | | | | | | | | | |
| Experimental | 0.65 | 0.65 | 0.33 | 100 | 22 | Poor | 1.05 | Good | 21 | Good | 34 | Good |
| Example 15 | | | | | | | | | | | | |
| Experimental | 0.65 | 0.62 | 0.33 | 96 | 17 | Poor | 1.08 | Good | 23 | Good | 28 | Good |
| Example 16 | | | | | | | | | | | | |
| Experimental | 0.65 | 0.59 | 0.33 | 90 | 12 | Poor | 1.10 | Good | 20 | Good | 35 | Good |
| Example 17 | | | | | | | | | | | | |
| Experimental | 0.65 | 0.55 | 0.33 | 84 | 8 | Poor | 1.07 | Good | 21 | Good | 33 | Good |
| Example 18 | | | | | | | | | | | | |
| Experimental | 0.65 | 0.52 | 0.33 | 80 | 3 | Good | 1.05 | Good | 18 | Good | 31 | Good |
| Example 19 | | | | | | | | | | | | |
| Experimental | 0.65 | 0.48 | 0.33 | 74 | 1 | Good | 1.11 | Good | 20 | Good | 35 | Good |
| Example 20 | | | | | | | | | | | | |
| Experimental | 0.65 | 0.46 | 0.33 | 70 | 0 | Excellent | 1.06 | Good | 20 | Good | 30 | Good |
| Example 21 | | | | | | | | | | | | |
| Experimental | 0.65 | 0.43 | 0.33 | 66 | 0 | Excellent | 1.05 | Good | 22 | Good | 39 | Good |
| Example 22 | | | | | | | | | | | | |
| Experimental | 0.65 | 0.39 | 0.33 | 60 | 0 | Excellent | 1.04 | Good | 25 | Good | 36 | Good |
| Example 23 | | | | | | | | | | | | |
| Experimental | 0.65 | 0.36 | 0.33 | 56 | 0 | Excellent | 1.09 | Good | 21 | Good | 33 | Good |
| Example 24 | | | | | | | | | | | | |
| Experimental | 0.65 | 0.33 | 0.33 | 50 | 0 | Excellent | 1.03 | Good | 24 | Good | 29 | Good |
| Example 25 | | | | | | | | | | | | |
| Experimental | 0.65 | 0.30 | 0.30 | 46 | 0 | Excellent | 1.08 | Good | 33 | Poor | 38 | Good |
| Example 26 | | | | | | | | | | | | |
| Experimental | 0.65 | 0.26 | 0.26 | 40 | 0 | Excellent | 0.95 | Poor | 41 | Poor | 34 | Good |
| Example 27 | | | | | | | | | | | | |
| Experimental | 0.65 | 0.22 | 0.22 | 34 | 0 | Excellent | 0.83 | Poor | 53 | Poor | 32 | Good |
| Example 28 | | | | | | | | | | | | |
| Experimental | 0.65 | 0.20 | 0.20 | 30 | 0 | Excellent | 0.70 | Poor | 68 | Poor | 36 | Good |
| Example 29 | | | | | | | | | | | | |

As shown in Table 1, with respect to the presence or absence of voids, a tendency was confirmed that better results were obtained as the A/C thickness ratio decreased. The determination results of the presence or absence of voids were as follows: when the A/C thickness ratio was 50% or more, the result was “Poor”; when the A/C thickness ratio was 46% or less, the result was “Good”; and when the A/C thickness ratio was 40% or less, the result was “Excellent”. The number of multilayer ceramic capacitors determined as “void present” was 6 when the A/C thickness ratio was 50%. When the A/C thickness ratio exceeded 50%, a tendency was confirmed that the number of multilayer ceramic capacitors determined as “void present” markedly increased as the A/C thickness ratio increased. Thus, it became clear that generation of voids can be suitably reduced by setting the A/C thickness ratio to less than about 50%. Further, since structural defects can be reduced or prevented by reducing generation of voids, it is possible to suitably reduce structural defects by setting the A/C thickness ratio to less than about 50%. Structural defects can be reduced more suitably by setting the A/C thickness ratio to 40% or less.

With respect to the electrostatic capacitance, when the A/C thickness ratio was 6%, the determination result was “Poor”, and when the A/C thickness ratio was 8% or more, the determination result was “Good”. When the A/C thickness ratio was 8% or more, the electrostatic capacitance was stable at a substantially constant value; whereas when the A/C thickness ratio was 6%, the electrostatic capacitance was significantly smaller than in other experimental examples. Thus, it became clear that a sufficient electrostatic capacitance of the multilayer ceramic capacitor can be ensured by setting the A/C thickness ratio to 8% or more.

With respect to the DC resistance (Rdc1), when the A/C thickness ratio was 8% or less, the determination result was “Poor”, and when the A/C thickness ratio was 10% or more, the determination result was “Good”. When the A/C thickness ratio was 10% or more, the DC resistance (Rdc1) was stable at a substantially constant value; whereas a tendency was confirmed that, when the A/C thickness ratio was 6% or less, the DC resistance (Rdc1) markedly decreased as the A/C thickness ratio decreased. With respect to the DC resistance (Rdc2), good results were obtained in all experimental examples. Thus, it became clear that the DC resistance (Rdc) of the multilayer ceramic capacitor can be sufficiently reduced by setting the A/C thickness ratio to 10% or more.

Therefore, it became clear that, when the A/C thickness ratio is about 10% or more and less than about 50% (i.e., when, in the end-surface inner electrode 20, the thickness of the first region 20a is about 10% or more and less than about 50% of the thickness of the third region 20c), it is possible to suitably reduce or prevent structural defects while sufficiently ensuring performance of the multilayer ceramic capacitor, and, when the thickness of the first region 20a is about 10% or more and not more than about 40% of the thickness of the third region 20c, structural defects can be reduced or prevented more suitably.

As shown in Table 2, with respect to the presence or absence of voids, a tendency was confirmed that better results were obtained as the B/C thickness ratio decreased. The determination results of the presence or absence of voids were as follows: when the B/C thickness ratio was 84% or more, the determination result was “Poor”; when the B/C thickness ratio was 80% or less, the determination result was “Good”; and when the B/C thickness ratio was 70% or less, the determination result was “Excellent”. The number of multilayer ceramic capacitors determined as “void present” was 8 when the B/C thickness ratio was 84%, and was 3 when the B/C thickness ratio was 80%. When the B/C thickness ratio exceeded 80%, a tendency was confirmed that the number of multilayer ceramic capacitors determined as “void present” markedly increased as the B/C thickness ratio increased. Thus, it became clear that generation of voids can be suitably reduced by setting the B/C thickness ratio to less than about 80%. Also, since structural defects can be reduced or prevented by reducing generation of voids, it is possible to suitably reduce or prevent structural defects by setting the B/C thickness ratio to less than about 80%. Structural defects can be reduced or prevented more suitably by setting the B/C thickness ratio to about 70% or less, for example.

With respect to the electrostatic capacitance, when the B/C thickness ratio was 40% or less, the determination result was “Poor”, and when the B/C thickness ratio was 46% or more, the determination result was “Good”. When the B/C thickness ratio was 46% or more, the electrostatic capacitance was stable at a substantially constant value; whereas a tendency was confirmed that, when the B/C thickness ratio was 40% or less, the electrostatic capacitance markedly decreased as the B/C thickness ratio decreased. Thus, it became clear that a sufficient electrostatic capacitance of the multilayer ceramic capacitor can be ensured by setting the B/C thickness ratio to 46% or more.

With respect to the DC resistance (Rdc1), when the B/C thickness ratio was 46% or less, the determination result was “Poor”, and when the B/C thickness ratio was 50% or more, the determination result was “Good”. When the B/C thickness ratio was 50% or more, the DC resistance (Rdc1) was stable at a substantially constant value; whereas a tendency was confirmed that, when the B/C thickness ratio was 46% or less, the DC resistance (Rdc1) markedly decreased as the B/C thickness ratio decreased. With respect to the DC resistance (Rdc2), good results were obtained in all experimental examples. Thus, it became clear that the DC resistance (Rdc) of the multilayer ceramic capacitor can be sufficiently reduced by setting the B/C thickness ratio to about 50% or more, for example.

Therefore, it became clear that, when the B/C thickness ratio is about 50% or more and less than about 80% (i.e., when, in the end-surface inner electrode 20, the thickness of the second region 20b is about 50% or more and less than about 80% of the thickness of the third region 20c), it is possible to suitably reduce or prevent structural defects while sufficiently ensuring performance of the multilayer ceramic capacitor, and, when the thickness of the second region 20b is about 50% or more and not more than about 70% of the thickness of the third region 20c, structural defects can be reduced or prevented more suitably.

According to the present example embodiment, the following effects can be obtained.

According to the present example embodiment, in the end-surface inner electrode 20, the dimension in the stacking direction T of the first region 20a is less than the dimension in the stacking direction T of the second region 20b adjacent to the first region 20a, and the dimension in the stacking direction T of the second region 20b is less than the dimension in the stacking direction T of the third region 20c adjacent to the second region 20b.

In such a case, the dimension of the end-surface inner electrode 20 in the stacking direction T decreases as it approaches the first end surface CA. Accordingly, the step due to the end-surface inner electrode 20 can be mitigated, and therefore pressure can be suitably applied to dielectric layers in the vicinity of the inner electrodes during thermocompression bonding of ceramic green sheets. Thus, structural defects, such as generation of voids, can be reduced or prevented. Therefore, it is possible to provide the multilayer ceramic capacitor 1 that allows structural defects to be reduced or prevented.

According to the present example embodiment, in the end-surface inner electrode 20, the dimension in the stacking direction T of the first region 20a is about 10% or more and less than about 50% of the dimension in the stacking direction T of the second region 20b, for example.

Accordingly, the step due to the end-surface inner electrode 20 can be suitably mitigated, and thus the end-surface inner electrode 20 and the dielectric layer 14 can be brought into close contact more suitably. Therefore, structural defects can be reduced or prevented more suitably.

According to the present example embodiment, in the end-surface inner electrode 20, the dimension in the stacking direction T of the second region 20b is about 50% or more and less than about 80% of the dimension in the stacking direction T of the third region 20c, for example.

Accordingly, the step due to the end-surface inner electrode 20 can be suitably mitigated, and thus the end-surface inner electrode 20 and the dielectric layer 14 can be brought into close contact more suitably. Therefore, structural defects can be reduced or prevented more suitably.

According to the present example embodiment, in the side-surface inner electrode 50, the dimension in the stacking direction T of the first region 50a is less than the dimension in the stacking direction T of the second region 50b adjacent to the first region 50a, and the dimension in the stacking direction T of the second region 50b is less than the dimension in the stacking direction T of the third region 50c adjacent to the second region 50b.

In such a case, the dimension of the side-surface inner electrode 50 in the stacking direction T decreases as it approaches the first side surface BA. Accordingly, the step due to the side-surface inner electrode 50 can be suitably mitigated, and thus the side-surface inner electrode 50 and the dielectric layer 14 can be brought into close contact suitably. Therefore, structural defects can be reduced or prevented more suitably.

According to the present example embodiment, in the side-surface inner electrode 50, the dimension in the stacking direction T of the first region 50a is about 10% or more and less than about 50% of the dimension in the stacking direction T of the second region 50b, for example.

Accordingly, the step due to the side-surface inner electrode 50 can be more suitably mitigated, and thus the side-surface inner electrode 50 and the dielectric layer 14 can be brought into close contact suitably. Therefore, structural defects can be reduced or prevented more suitably.

According to the present example embodiment, in the side-surface inner electrode 50, the dimension in the stacking direction T of the second region 50b is about 50% or more and less than about 80% of the dimension in the stacking direction T of the third region 50c, for example.

Accordingly, the step due to the side-surface inner electrode 50 can be more suitably mitigated, and thus the side-surface inner electrode 50 and the dielectric layer 14 can be brought into close contact suitably. Therefore, structural defects can be reduced or prevented more suitably.

Example embodiments of the present invention have been described above. However, the present invention is not limited to the above-described example embodiments, and various modifications and variations are possible.

For example, it is sufficient that the condition that the dimension in the stacking direction of the first region is less than the dimension in the stacking direction T of the second region and that the dimension in the stacking direction T of the second region is less than the dimension in the stacking direction T of the third region be satisfied in at least portions of the peripheral edge portions of the inner electrodes 15. Also, the condition need not be satisfied in all of the plurality of inner electrodes, and it is sufficient that the condition be satisfied in at least some of the inner electrodes. However, the condition is preferably satisfied in as many portions of the inner electrodes 15 as possible, and is preferably satisfied in as many inner electrodes 15 among the plurality of inner electrodes 15 as possible, which allows structural defects to be reduced or prevented more reliably.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of dielectric layers and a plurality of inner electrodes alternately stacked on each other, the multilayer body including a first main surface and a second main surface facing each other in a stacking direction, a first side surface and a second side surface facing each other in a width direction orthogonal to the stacking direction, and a first end surface and a second end surface facing each other in a length direction orthogonal to the stacking direction and the width direction;
a pair of side-surface outer electrodes provided on the respective side surfaces; and
a pair of end-surface outer electrodes provided on the respective end surfaces; wherein
the plurality of inner electrodes include an end-surface inner electrode exposed at both of the respective end surfaces and a side-surface inner electrode exposed at both of the respective side surfaces; and
when a straight line extending in the stacking direction and passing through a position that is a central portion of the multilayer body in the length direction and is a central portion of the multilayer body in the width direction is defined as a reference line, at a position overlapping the reference line, a cross section of the multilayer body extending parallel to the stacking direction is defined as a reference cross section;
in the reference cross section, a direction orthogonal to the stacking direction is defined as a reference direction;
in the reference cross section, a distance between an end portion of each of the inner electrodes in the reference direction and the reference line is defined as a reference distance;
in the reference cross section, in at least one of the plurality of inner electrodes, a region in which a distance in the reference direction from the end portion in the reference direction is less than about 5% of the reference distance is defined as a first region, a region in which the distance in the reference direction from the end portion in the reference direction is about 5% or more and less than about 15% of the reference distance is defined as a second region, and a region in which the distance in the reference direction from the end portion in the reference direction is about 15% or more of the reference distance is defined as a third region;
in the end-surface inner electrode, a dimension in the stacking direction of the first region is less than a dimension in the stacking direction of the second region adjacent to the first region, and the dimension in the stacking direction of the second region is less than a dimension in the stacking direction of the third region adjacent to the second region.

2. The multilayer ceramic capacitor according to claim 1, wherein, in the end-surface inner electrode, the dimension in the stacking direction of the first region is about 10% or more and less than about 50% of the dimension in the stacking direction of the second region.

3. The multilayer ceramic capacitor according to claim 1, wherein, in the end-surface inner electrode, the dimension in the stacking direction of the second region is about 50% or more and less than about 80% of the dimension in the stacking direction of the third region.

4. The multilayer ceramic capacitor according to claim 1, wherein, in the side-surface inner electrode, the dimension in the stacking direction of the first region is less than the dimension in the stacking direction of the second region adjacent to the first region, and the dimension in the stacking direction of the second region is less than the dimension in the stacking direction of the third region adjacent to the second region.

5. The multilayer ceramic capacitor according to claim 4, wherein, in the side-surface inner electrode, the dimension in the stacking direction of the first region is about 10% or more and less than about 50% of the dimension in the stacking direction of the second region.

6. The multilayer ceramic capacitor according to claim 5, wherein, in the side-surface inner electrode, the dimension in the stacking direction of the second region is about 50% or more and less than about 80% of the dimension in the stacking direction of the third region.

7. The multilayer ceramic capacitor according to claim 1, wherein the multilayer ceramic capacitor is a three terminal multilayer ceramic capacitor.

8. The multilayer ceramic capacitor according to claim 1, wherein the multilayer body includes rounded corners and rounded ridges.

9. The multilayer ceramic capacitor according to claim 1, wherein all of the plurality of inner electrodes include the first region in which the distance in the reference direction from the end portion in the reference direction is less than about 5% of the reference distance, the second region in which the distance in the reference direction from the end portion in the reference direction is about 5% or more and less than about 15% of the reference distance, and the third region in which the distance in the reference direction from the end portion in the reference direction is about 15% or more of the reference distance.

10. The multilayer ceramic capacitor according to claim 1, wherein in the side-surface inner electrode, a dimension in the stacking direction of the first region is less than a dimension in the stacking direction of the second region adjacent to the first region, and the dimension in the stacking direction of the second region is less than a dimension in the stacking direction of the third region adjacent to the second region.

11. A multilayer ceramic capacitor comprising:
a multilayer body including an inner layer portion including a plurality of dielectric layers and a plurality of inner electrodes alternately stacked on each other, the multilayer body including a first main surface and a second main surface facing each other in a stacking direction, a first side surface and a second side surface facing each other in a width direction orthogonal to the stacking direction, and a first end surface and a second end surface facing each other in a length direction orthogonal to the stacking direction and the width direction;
a pair of side-surface outer electrodes provided on the respective side surfaces; and
a pair of end-surface outer electrodes provided on the respective end surfaces;
wherein
the plurality of inner electrodes include an end-surface inner electrode exposed at both of the respective end surfaces and a side-surface inner electrode exposed at both of the respective side surfaces; and
when a straight line extending in the stacking direction and passing through a position that is a central portion of the multilayer body in the length direction and is a central portion of the multilayer body in the width direction is defined as a reference line;
any point on a peripheral edge portion of each of the inner electrodes is defined as a reference point;
a direction in which the reference point and the reference line are arranged is defined as a reference direction;
a distance between the reference point and the reference line is defined as a reference distance; and
in at least one of the plurality of inner electrodes, a region in which a distance in the reference direction from the reference point is less than about 5% of the reference distance is defined as a first region, a region in which the distance in the reference direction from the reference point is about 5% or more and less than about 15% of the reference distance is defined as a second region, and a region in which the distance in the reference direction from the reference point is about 15% or more of the reference distance is defined as a third region; and
in the side-surface inner electrode, a dimension in the stacking direction of the first region is less than a dimension in the stacking direction of the second region adjacent to the first region, and the dimension in the stacking direction of the second region is less than a dimension in the stacking direction of the third region adjacent to the second region.

12. The multilayer ceramic capacitor according to claim 11, wherein, in the end-surface inner electrode, the dimension in the stacking direction of the first region is about 10% or more and less than about 50% of the dimension in the stacking direction of the second region.

13. The multilayer ceramic capacitor according to claim 11, wherein, in the end-surface inner electrode, the dimension in the stacking direction of the second region is about 50% or more and less than about 80% of the dimension in the stacking direction of the third region.

14. The multilayer ceramic capacitor according to claim 11, wherein, in the side-surface inner electrode, the dimension in the stacking direction of the first region is less than the dimension in the stacking direction of the second region adjacent to the first region, and the dimension in the stacking direction of the second region is less than the dimension in the stacking direction of the third region adjacent to the second region.

15. The multilayer ceramic capacitor according to claim 14, wherein, in the side-surface inner electrode, the dimension in the stacking direction of the first region is about 10% or more and less than about 50% of the dimension in the stacking direction of the second region.

16. The multilayer ceramic capacitor according to claim 15, wherein, in the side-surface inner electrode, the dimension in the stacking direction of the second region is about 50% or more and less than about 80% of the dimension in the stacking direction of the third region.

17. The multilayer ceramic capacitor according to claim 11, wherein the multilayer ceramic capacitor is a three terminal multilayer ceramic capacitor.

18. The multilayer ceramic capacitor according to claim 11, wherein the multilayer body includes rounded corners and rounded ridges.

19. The multilayer ceramic capacitor according to claim 11, wherein all of the plurality of inner electrodes include the first region in which the distance in the reference direction from the end portion in the reference direction is less than about 5% of the reference distance, the second region in which the distance in the reference direction from the end portion in the reference direction is about 5% or more and less than about 15% of the reference distance, and the third region in which the distance in the reference direction from the end portion in the reference direction is about 15% or more of the reference distance.

20. The multilayer ceramic capacitor according to claim 11, wherein in the end-surface inner electrode, a dimension in the stacking direction of the first region is less than a dimension in the stacking direction of the second region adjacent to the first region, and the dimension in the stacking direction of the second region is less than a dimension in the stacking direction of the third region adjacent to the second region.
